(19) United States
(12) Patent Application Publication
(10) Pub. No.: US 2024/0127345 A1
(43) Pub. Date: Apr. 18, 2024

(54) METHOD FOR TRADING IN CRYPTO EXCHANGE USING AN ARTIFICIAL INTELLIGENCE CRYPTO TRADING BOT

(71) Applicant: Shimza Ali Khan, Dallas, TX (US)

(72) Inventor: Shimza Ali Khan, Dallas, TX (US)

(21) Appl. No.: 18/177,821

(22) Filed: Mar. 3, 2023

Related U.S. Application Data
(63) Continuation-in-part of application No. 63/379,907, filed on Oct. 18, 2022.

(51) Int. Cl. G06Q 40/06; G06Q 40/04

(52) U.S. Cl. CPC G06Q 40/06; G06Q 40/04

(57) ABSTRACT

A system and method for generating an artificial intelligence trading bot in crypto exchange is provided. The method includes receiving input of past and current data of market information and a plurality of predicted signals. The method includes extracting a plurality of features from the input. The method includes generating a artificial intelligence trading bot based on the plurality of features using one or more machine learning models. The method includes suggesting a profit leading trade strategy to trade on crypto exchange in a live market via the artificial intelligence trading bot. The method includes allowing a user to trade in the current market with fabricated money thereby testing the bot to evaluate the said profit leading trade strategy and present an associated profit to the user. The method includes generating a signal for buy or sell as an output and presenting the output to the user.

### EARLIEST PRIORITY DATE

This Application claims priority from a Provisional patent application filed in the United States of America having Patent Application No. 63/379,907, filed on Oct. 18, 2022, and titled “A METHOD FOR TRADING IN CRYPTO EXCHANGE USING AN ARTIFICIAL INTELLIGENCE CRYTO TRADING BOT.”

### FIELD OF INVENTION

Embodiments of the present disclosure relate to a field of cryptocurrency trading and more particularly to a method for trading in crypto exchange using an artificial intelligence crypto trading bot.

### BACKGROUND

A cryptocurrency is a digital currency and is known for being incredibly volatile, with prices fluctuating dramatically within minutes. Investors could participate in cryptocurrency trading worldwide and at any time of the day in cryptocurrency exchanges. Several factors limit the effectiveness of human cryptocurrency trading. In many cases, investors cannot theoretically react fast enough to price changes to make ideal trades available. Slowdowns in exchanges and transaction times further exacerbate this problem. Likewise, investors cannot always spend a lot of time in the cryptocurrency markets to get the best trades. This requires 24/7 monitoring of cryptocurrency exchanges around the world.

To increase the trading efficiency and profitability, the development of intelligent bots in the market has begun that conduct trades and execute transactions on behalf of human investors. However, some bot platforms fail while taking actions because of the extremely volatile conditions in the market. It takes unexpected decisions on behalf of investors, leading to a minor gain or loss, depending on the cryptocurrency prices. Most of these problems in bots are due to the limited knowledge of the financial strategies in the market. Further, many bots are simply not designed well as they won't consider performance in historical periods and risk, reward and the like.

Hence, there is a need for an improved system for performing trades in crypto exchange to address the aforementioned issue(s).

### OBJECTIVE OF THE INVENTION

An object of the present invention is to generate an artificial intelligence trading bot that is adapted to perform trades in crypto exchanges and generate profits in various market conditions.

### BRIEF DESCRIPTION

A method for generating an artificial intelligence trading bot for trading in crypto exchange is provided. The method includes receiving, by a data collection module of a processing subsystem, an input wherein the input comprises past data and current data of market information and a plurality of predicted signals for trading corresponding to a trading market. The method also includes extracting, by a feature extraction module of the processing subsystem, a plurality of features from the input, upon receiving, wherein the plurality of features comprises volatility related features, technical indicators, financial strategies and trend related features. Further, the method includes generating, by a bot generation module of an artificial intelligence module, a bot based on the plurality of features using one or more machine learning models wherein the one or more machine learning models is trained with the input to analyze the trading market. Furthermore, the method includes suggesting, by a prediction module of the artificial intelligence module, a profit leading trade strategy to trade on crypto exchange in a live market via the bot using the one or more machine learning models. Moreover, the method includes allowing, by a test module of the processing subsystem, a user to trade in the current market with fabricated money based on the profit leading trade strategy, upon prediction, thereby testing the bot to evaluate the said profit leading trade strategy and present an associated profit to the user. The method includes generating, by a signal module of the processing subsystem, at least one of a buy signal and a sell signal as an output based on the one or more machine learning models and intelligence of a plurality of factors. The method also includes presenting, by a trade bot interface, the output to the user thereby preparing the user with confidence on the artificial intelligence trading bot to trade with real money.

A system for generating an artificial intelligence trading bot for trading in crypto exchange using artificial intelligence is provided. The system includes a processing subsystem hosted on a server, wherein the processing subsystem is configured to execute on a network to control bidirectional communications among a plurality of modules. The processing subsystem includes a data collection module configured to receive an input wherein the input comprises past data and current data of market information and a plurality of predicted signals for trading corresponding to a trading market. The processing subsystem includes a feature extraction module operatively coupled to the data collection module wherein the feature extraction module is configured to extract a plurality of features from the input, upon receiving, wherein the plurality of features comprises volatility related features, technical indicators, financial strategies and trend related features. Further, the processing subsystem includes an artificial intelligence module operatively coupled to the feature extraction module. The artificial intelligence module includes a bot generation module to generate the bot based on the plurality of features using one or more machine learning models wherein the one or more machine learning models is trained with the input to analyze the trading market. Further, the artificial intelligence module includes a prediction module to suggest a profit leading trade strategy to trade on crypto exchange in a live market via the bot using the one or more machine learning models. The processing subsystem includes a test module operatively coupled to the artificial intelligence module wherein the test module is configured to allow a user to trade in the current market with fabricated money based on the profit leading trade strategy, upon prediction, thereby testing the bot to evaluate the said profit leading trade strategy and present an associated profit to the user. Further, the processing subsystem includes a signal module operatively coupled to the test module wherein the signal module is configured to generate at least one of a buy signal and a sell signal as an output based on the one or more machine learning models and intelligence of a plurality of factors. Furthermore, the processing subsystem includes a trade bot interface operatively coupled to the signal module wherein the trade bot interface is configured to present the output to the user thereby preparing the user with confidence on the artificial intelligence trading bot to trade with real money.

### BRIEF DESCRIPTION OF THE DRAWINGS

The disclosure will be described and explained with additional specificity and detail with the accompanying figures in which:

FIG. 1 is a block diagram representation of system for generating an artificial intelligence trading bot for trading in crypto exchange using artificial intelligence in accordance with an embodiment of the present disclosure;

FIG. 2 is a schematic representation of an artificial intelligence crypto trading bot to perform a method for trading in crypto exchange in accordance with an embodiment of the present disclosure;

FIG. 3 is a block diagram of a computer or a server for system in accordance with an embodiment of the present disclosure;

FIG. 4a illustrates a flowchart representing the steps involved in a method for trading in crypto exchange in accordance with an embodiment of the present disclosure; and

FIG. 4b illustrates a flow chart representing the continued steps involved in the method of FIG. 4a in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, crypto currency exchange refers to a marketplace that trades cryptocurrency held by a specific user with fiat currency or another cryptocurrency.

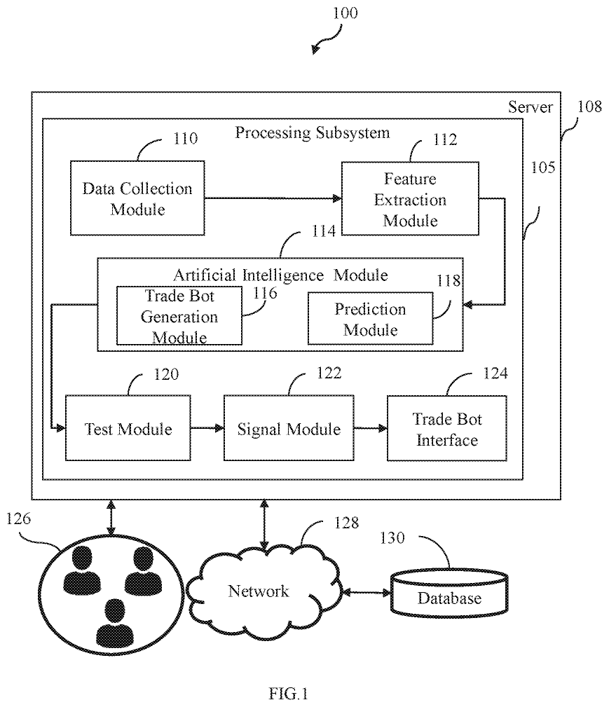

FIG. 1 is a block diagram representation of system 100 for generating an artificial intelligence trading bot for trading in crypto exchange using artificial intelligence in accordance with an embodiment of the present disclosure. The system 100 includes a processing subsystem 105. The processing subsystem 105 may be hosted on a server 108. In one embodiment, the server 108 may include a cloud server. In another embodiment, the server 108 may include a local server. In yet another embodiment, the processing subsystem 105 may be configured in integrated circuits such as smart card, microchip and the like. The processing subsystem 105 is configured to execute on a network 128 to control bidirectional communications among a plurality of modules. In one embodiment, the network 128 may include a wired network such as a local area network (LAN). In another embodiment, the network may include a wireless network such as wireless fidelity (Wi-Fi), Bluetooth, Zigbee, near field communication (NFC), infrared communication, or the like.

The system 100 proposed in the present disclosure may be used to generate an artificial intelligence trading bot for trading in crypto exchange. Furthermore, one or more users 126 willing to use the system 100 may register with the system 100. Thus, in an embodiment, the system 100 may include a registration module (not shown in FIG. 1). The registration module may register the one or more users 126 with the system 100 upon receiving a plurality of user details via a user device. In one embodiment, the plurality of user details may be stored in a database 130 of the system 100. In one embodiment, the database 130 may include a local database or a cloud database. Moreover, in an embodiment, the database 130 may be hybrid, wherein the database 130 may include a decentralized database and a centralized database. The plurality of user details may include a name, contact details, a unique identity proof, and the like. Examples of the user device includes, but is not limited to, a mobile phone, desktop computer, portable digital assistant (PDA), smart phone, tablet, ultra-book, netbook, laptop, multi-processor system, microprocessor-based or programmable consumer electronic system, or any other communication device that the one or more users 126 may use.

In one exemplary embodiment, the one or more users 126 include individuals who are interested in crypto exchange. As used herein, ‘crypto exchange’ may also be referred as ‘cryptocurrency exchange’ or ‘Digital Currency Exchange (DCE)’. Typically, crypto exchange enable transactions involving the exchange of value (such as using currency, cryptocurrency, tokens, rewards or the like, as well as a wide range of in-kind and other resources) in various markets, including current or spot markets, forward markets and the like, for various goods, services, and resources.

The processing subsystem 105 includes a data collection module 110 configured to receive an input. The input includes past data and current data of market information and a plurality of predicted signals for trading corresponding to a trading market. Typically, market information from a plurality of crypto exchanges is aggregated.

The processing subsystem 105 includes a feature extraction module 112 operatively coupled to the data collection module 110. Further, the feature extraction module 112 is configured to extract a plurality of features from the input, upon receiving, wherein the plurality of features comprises volatility related features, technical indicators, financial strategies and trend related features.

The processing subsystem 105 includes an artificial intelligence module 114 operatively coupled to the feature extraction module 112. Further, the artificial intelligence module 114 includes a trade bot generation module 116 and a prediction module 118. The trade bot generation module 116 is configured to generate the trading bot based on the plurality of features using one or more machine learning models wherein the one or more machine learning models is trained with the input to analyze the trading market. Similarly, the prediction module 118 is configured to suggest a profit leading trade strategy to trade on crypto exchange in a live market via the trading bot using the one or more machine learning models.

The processing subsystem 105 includes a test module 120 operatively coupled to the artificial intelligence module 114. The test module 120 is configured to allow a user to trade in the current market with fabricated money based on the profit leading trade strategy, upon prediction, thereby testing the trading bot to evaluate the said profit leading trade strategy and present an associated profit to the user. It must be noted that the fabricated money is defined as paper money that mimics real money.

In one embodiment, the system 100 uses crypto ledgers or distributed ledgers (for example, block chains) to verify ownership and availability of the digital transactional items being exchanged.

The processing subsystem 105 includes a signal module 122 operatively coupled to the test module 120. Further, the signal module 122 is configured to generate at least one of a buy signal and a sell signal as an output based on the one or more machine learning models and intelligence of a plurality of factors.

The processing subsystem 105 includes a trade bot interface 124 operatively coupled to the signal module 122 wherein the trade bot interface 124 is configured to present the output to the user.

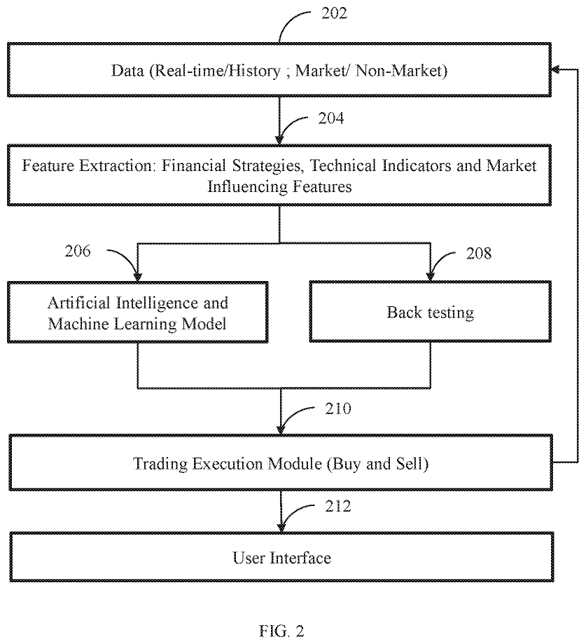

FIG. 2 is a schematic representation of an artificial intelligence crypto trading bot to perform a method for trading in crypto exchange in accordance with an embodiment of the present disclosure. The method begins with collection of data 202. Typically, the data is a combination of real-time information and historical information pertaining to a plurality of markets and non-markets.

A plurality of features are extracted from the data 204. The features include financial strategies, technical indicators and market influencing features. Subsequently, the features are fed as training data to one or more artificial intelligence and machine learning models 206. The training data enables the generation of an artificial intelligence trading bot that is capable for trading in crypto exchange. In one embodiment, one or more users are allowed to perform back testing on the machine learning models 208. The back testing is a technique that allows the one or more users to test the artificial intelligence trading bot with fabricated money (also referred as paper money) thereby identifying a profitable buy or sell for a crypto exchange. A final signal is generated by a trading execution module for the said buy or sell crypto exchange 210. The final signal is presented to the one or more users through a user interface 112 (also referred as trade bot interface 124) configured with a corresponding user device.

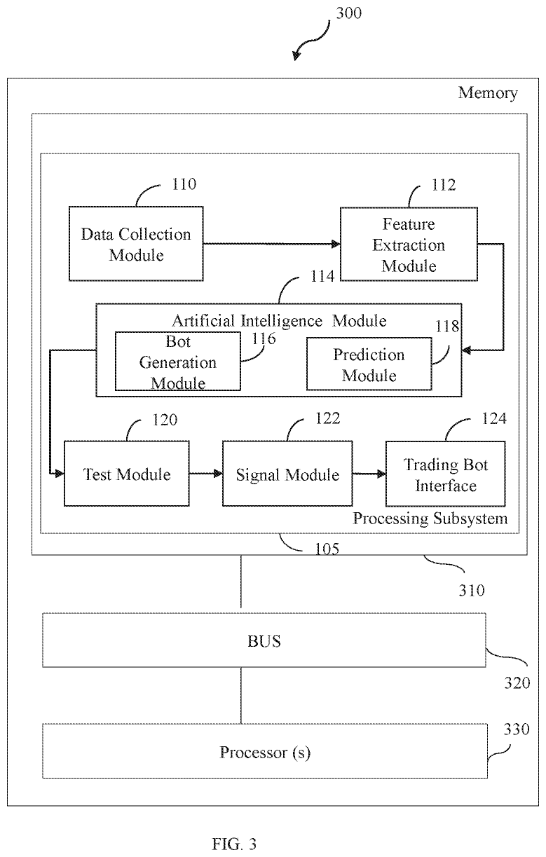

FIG. 3 is a block diagram of a computer or a server for system in accordance with an embodiment of the present disclosure. The server includes 108 includes processor(s) 330, and memory 310 operatively coupled to a bus 320. The processor(s) 330, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 330.

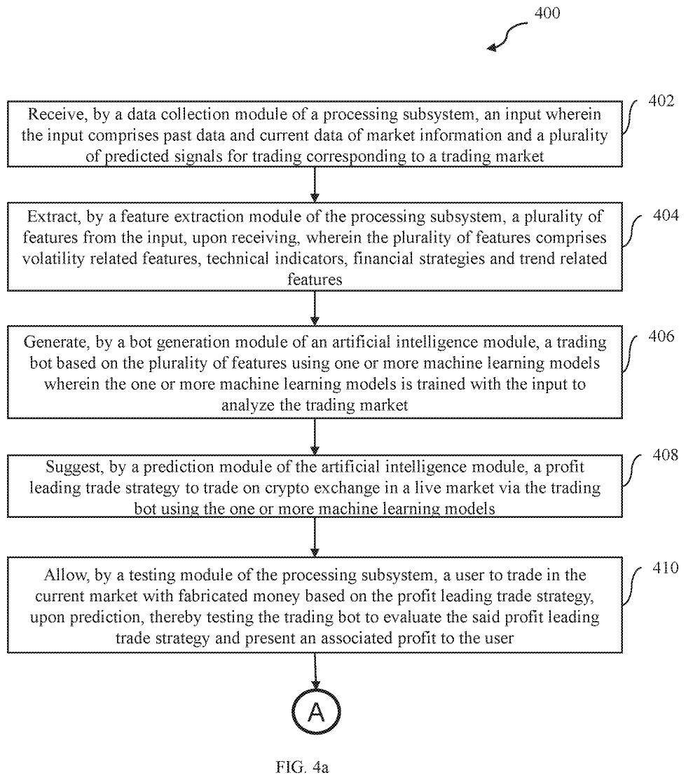

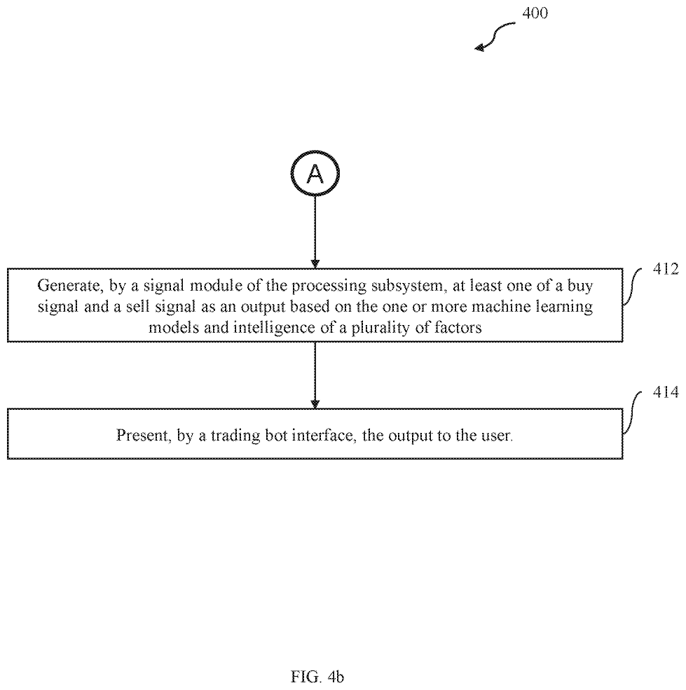

The memory 310 includes a plurality of subsystems stored in the form of executable program which instructs the processor(s) 330 to perform method steps illustrated in FIG. 4. The memory 310 includes a processing subsystem 105 of FIG. 1. The processing subsystem 105 further has following modules: a data collection module 110, a feature extraction module 112, an artificial intelligence module 114, a test module 120, a signal module 122 and a trade bot interface 124. Further, the artificial intelligence module 114 includes a trade bot generation module 116 and a prediction module 118.

The processing subsystem 105 is configured to execute on a network (as shown in FIG. 1) to control bidirectional communications among a plurality of modules. The processing subsystem 105 includes the data collection module 110 configured to receive an input wherein the input comprises past data and current data of market information and a plurality of predicted signals for trading corresponding to a trading market. The processing subsystem 105 includes the feature extraction module 112 operatively coupled to the data collection module 110 wherein the feature extraction module 112 is configured to extract a plurality of features from the input, upon receiving, wherein the plurality of features comprises volatility related features, technical indicators, financial strategies and trend related features. Further, the processing subsystem includes the artificial intelligence module 114 operatively coupled to the feature extraction module 112. The artificial intelligence module 114 includes a trade bot generation module 116 to generate the bot based on the plurality of features using one or more machine learning models wherein the one or more machine learning models is trained with the input to analyze the trading market. Further, the artificial intelligence module 114 includes a prediction module 118 to suggest a profit leading trade strategy to trade on crypto exchange in a live market via the bot using the one or more machine learning models. The processing subsystem 105 includes a test module 120 operatively coupled to the artificial intelligence module 114 wherein the test module 120 is configured to allow a user to trade in the current market with fabricated money based on the profit leading trade strategy, upon prediction, thereby testing the trade bot to evaluate the said profit leading trade strategy and present an associated profit to the user. Further, the processing subsystem 105 includes the signal module 122 operatively coupled to the test module 120 wherein the signal module 122 is configured to generate at least one of a buy signal and a sell signal as an output based on the one or more machine learning models and intelligence of a plurality of factors. Furthermore, the processing subsystem 105 includes the trade bot interface 124 operatively coupled to the signal module wherein the trade bot interface 124 is configured to present the output to the user thereby preparing the user with confidence on the artificial intelligence trading bot to trade with real money.

The bus 320 as used herein refers to be internal memory channels or computer network that is used to connect computer components and transfer data between them. The bus 320 includes a serial bus or a parallel bus, wherein the serial bus transmits data in a bit-serial format and the parallel bus transmits data across multiple wires. The bus 320 as used herein, may include but not limited to, a system bus, an internal bus, an external bus, an expansion bus, a frontside bus, a backside bus, and the like.

FIG. 4 illustrates a flow chart representing the steps involved in a method 400 for trading in crypto exchange in accordance with an embodiment of the present disclosure. FIG. 4b illustrates a flow chart representing the continued steps involved in the method of FIG. 4a in accordance with an embodiment of the present disclosure. The method 400 begins at step 402.

At step 402, an input is received, by a data collection module of a processing subsystem. The input comprises past data and current data of market information and a plurality of predicted signals for trading corresponding to a trading market.

At step 404, a plurality of features are extracted, by a feature extraction module of the processing subsystem, upon receiving the input, The plurality of features comprises volatility related features, technical indicators, financial strategies and trend related features.

At step 406, a trading bot is generated, by a bot generation module of an artificial intelligence module, based on the plurality of features using one or more machine learning models. The one or more machine learning models is trained with the input to analyze the trading market.

The trading bot is an intelligent bot that would trade on crypto exchange. Further, the trading bot is built using the knowledge from the financial strategies and machine learning models. Specifically, the financial strategies and technical indicators are considered as the features or training set into the artificial intelligence or machine learning model that would predict the signal for buy or sell.

In one embodiment, the trading bot is also configured for extreme conditions and user constraints that would be followed while taking actions (buy or sell) in the market.

At step 408, a profit leading trade strategy to trade on crypto exchange in alive market is suggested, by a prediction module of the artificial intelligence module, via the trading bot using the one or more machine learning models.

In one embodiment, various market factors in any available structured or unstructured format are considered to generate the trading bot thereby covering various aspects of behaviour in the real world that drives the market.

At step 410, a user is allowed to trade in the current market with fabricated money, by a test module of the processing subsystem, based on the profit leading trade strategy, upon prediction, thereby testing the trading bot to evaluate the said profit leading trade strategy and present an associated profit to the user.

It must be noted that the testing of the trading bot may be performed with multiple machine learning models thereby producing consistent and stable results. Further, the trading bot is generated using latest technologies that considers scalability of application, security, governance and compliance, backup and recovery with cloud backed services.

The trading bot is also built using the testing or ‘back testing’ the performance on historical data. Subsequently, a corresponding risk or reward is considered.

At step 412, at least one of a buy signal and a sell signal is generated as an output, by a signal module of the processing subsystem based on the one or more machine learning models and intelligence of a plurality of factors. The plurality of factors are parameters tested and experimented on through research. Further, the plurality of factors explains the behaviour of the market by analyzing the past data. The artificial intelligence trading bot uses the said plurality of factors to predict signals for the future. Examples of the plurality of factors includes, but is not limited to, volatility related features, technical indicators, financial strategies, trend related features and the like that are derived on the top of basic market data. Further, relationships or correlation between crypto coins behaviour with Macro/Micro finance (other market factors) those reflects on to Crypto market are also considered to predict the signals. Consequently, the artificial intelligence trading bot considers the intelligence of the plurality of factors to generate the signals.

The output may be considered as the final buy or sell signal from the one or more machine learning models. The best strategies are combined with a voting process that produces maximum likelihood equation for the output. In one embodiment, the voting process may be implemented with weights that are decided based on the performance of trades from the past and live data. The weighed voting process ensures that more confident signals are generated and that the artificial intelligence bot is trained to produce accurate winning signals.

In one embodiment, the user is an investor who will take the decision to trade on crypto exchange using the trade bot with tested performance.

In another embodiment, other complex financial strategies are developed and automated to generate the buy and sell signal those will be providing the signal based on the trader's analysis.

At step 414, the output is presented to the user, by a trade bot interface.

The method ends at step 414.

Various embodiments of the present disclosure as disclosed provides consistent and stable results in extremely volatile conditions in the market. Further, provides improved trading efficiency, profitability and better user experience.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications are being made to the method to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A method for generating an artificial intelligence trading bot for trading in crypto exchange comprising:
receiving, by a data collection module of a processing subsystem, an input wherein the input comprises past data and current data of market information and a plurality of predicted signals for trading corresponding to a trading market;
extracting, by a feature extraction module of the processing subsystem, a plurality of features from the input, upon receiving, wherein the plurality of features comprises volatility related features, technical indicators, financial strategies and trend related features;
generating, by a bot generation module of an artificial intelligence module, an artificial intelligence trading bot based on the plurality of features using one or more machine learning models wherein the one or more machine learning models is trained with the input to analyze the trading market;
suggesting, by a prediction module of the artificial intelligence module, a profit leading trade strategy to trade on crypto exchange in a live market via the artificial intelligence trading bot using the one or more machine learning models;
allowing, by a test module of the processing subsystem, a user to trade in the current market with fabricated money based on the profit leading trade strategy, upon prediction, thereby testing the artificial intelligence trading bot to evaluate the said profit leading trade strategy and present an associated profit to the user;
generating, by a signal module of the processing subsystem, at least one of a buy signal and a sell signal as an output based on the one or more machine learning models and intelligence of a plurality of factors; and
presenting, by a trade bot interface, the output to the user thereby preparing the user with confidence on the artificial intelligence trading bot to trade with real money.

2. The method as claimed in claim 1 wherein the artificial intelligence trading bot is generated using a combination of knowledge from financial strategies and the one or more machine learning models.

3. The method as claimed in claim 1 wherein the output is generated based on a voting from a plurality of registered users.

4. The method as claimed in claim 3 wherein the voting is performed with a plurality of weights wherein the said weights are based on performance of profit leading trade strategies of the past and real-time data to produce a potential likelihood equation for trading in crypto exchange and predict an optimized call on the live market.

5. The method as claimed in claim 1 wherein the output is generated corresponding to multiple market conditions.

6. The method as claimed in claim 1 wherein the artificial intelligence trade bot is tested using statistical metrics.

7. The method as claimed in claim 1 wherein one of a reward and risk is presented upon testing the trade bot.

8. The method as claimed in claim 1 comprises:
storing the past data and the current data of market information and the plurality of predicted signals for trading corresponding to a trading market in a database.

9. A system for generating an artificial intelligence trading bot for trading in crypto exchange comprising:
a processing subsystem hosted on a server, wherein the processing subsystem is configured to execute on a network to control bidirectional communications among a plurality of modules comprising:
a data collection module configured to receive an input wherein the input comprises past data and current data of market information and a plurality of predicted signals for trading corresponding to a trading market;
a feature extraction module operatively coupled to the data collection module wherein the feature extraction module is configured to extract a plurality of features from the input, upon receiving, wherein the plurality of features comprises volatility related features, technical indicators, financial strategies and trend related features;
an artificial intelligence module operatively coupled to the feature extraction module wherein the artificial intelligence module comprises:
a bot generation module to generate the artificial intelligence trading bot based on the plurality of features using one or more machine learning models wherein the one or more machine learning models is trained with the input to analyze the trading market; and
a prediction module to suggest a profit leading trade strategy to trade on crypto exchange in a live market via the artificial intelligence trading bot using the one or more machine learning models;
a test module operatively coupled to the artificial intelligence module wherein the test module is configured to allow a user to trade in the current market with fabricated money based on the profit leading trade strategy, upon prediction, thereby testing the artificial intelligence trading bot to evaluate the said profit leading trade strategy and present an associated profit to the user;
a signal module operatively coupled to the test module wherein the signal module is configured to generate at least one of a buy signal and a sell signal as an output based on the one or more machine learning models and intelligence of a plurality of factors; and
a trade bot interface operatively coupled to the signal module wherein the trade bot interface is configured to present the output to the user thereby preparing the user with confidence on the artificial intelligence trading bot to trade with real money.

10. The system as claimed in claim 9 wherein the test module is configured to generate the output based on a voting from a plurality of registered users.

11. The system as claimed in claim 10 wherein the voting is performed with a plurality of weights wherein the said weights are based on performance of profit leading trade strategies of the past and real-time data to produce a potential likelihood equation for trading in crypto exchange and predict an optimized call on the live market.

12. The system as claimed in claim 9 wherein the test module is configured to generate the output based on historical data.

13. The system as claimed in claim 9 comprising an aggregation module configured to develop a probability signal through the machine learning model to provide an aggregate call thereby enabling the artificial intelligence trading bot to produce winning signals for trading in crypto exchange.

14. The system as claimed in claim 9 comprising a trading execution module to perform the crypto exchange.

15. The system as claimed in claim 9 wherein the past data and the current data of market information and the plurality of predicted signals for trading corresponding to the trading market is stored in a database.
